(19) United States
(12) Patent Application Publication
(10) Pub. No.: US 2012/0030976 A1
(43) Pub. Date: Feb. 9, 2012

(54) PINHOLE PUNCHED GREETING CARDS

(76) Inventors: Melinda Jo Leeders, Canton, OH (US); Daniel Eugene Robinson, Osceola, AR (US)

(21) Appl. No.: 13/181,814

(22) Filed: Jul. 13, 2011

Related U.S. Application Data
(60) Provisional application No. 61/364,060, filed on Jul. 14, 2010.

(51) Int. Cl. G09F 1/00; B26F 1/14

(52) U.S. Cl. 40/124.01; 83/30

(57) ABSTRACT

A pinhole punched greeting card and process for the mass production of same. The process facilitates mass production of a pinhole punched greeting card by enabling the production of all pinholes simultaneously which until the present invention required making each individual pinhole one at a time. The process utilizes a metal die and counter. The metal die containing a plurality of individual cone-shaped protrusions configured in a design pattern and a metal counter which is the reverse of the metal die. The greeting card is placed and secured between the metal die and counter, then the metal die and counter are compressed together thereby making a plurality of pinhole punctures in the greeting card which correspond to the plurality of cone-shaped protrusions contained upon the metal die and counter.

### RELATED APPLICATIONS

This application claims priority to U.S. Provisional patent application Ser. No. 61/364,060, filed on Jul. 14, 2010, which is incorporated herein by reference in its entirety.

### FIELD OF THE INVENTION

The present disclosure and related inventions are in the field of greeting cards and more specifically pertaining to methods of manufacturing certain types of greeting cards.

### BACKGROUND OF THE INVENTION

Paper based greeting cards and invitations typically contain printed artwork and text sentiment to convey a message to the recipient. Oftentimes, the artwork and/or text sentiment is made more noticeable by using embossing techniques. Embossing creates a raised area on the surface of the card that is most noticeable when felt or when light is skimmed across the raised areas. An embossed greeting card gives a three dimensional contour to the conventional two dimensional greeting card design and adds to the aesthetic appeal of the card. The process of embossing elements of a greeting card is known in the art. Embossing is typically performed by means of metal dies which are mounted in a press and operate in conjunction with a plastic counter to emboss a selected design onto paper stock used to form greeting cards, invitations or the like. Various techniques for making molded printing plates for embossing are disclosed in the following patents: U.S. Pat. No. 250,239 to Hansen; U.S. Pat. No. 2,826,811 to Shikes, U.S. Pat. No. 4,001,062 to Iisaka et al. and U.S. Pat. No. 4,579,708 to Rosart.

### SUMMARY OF THE INVENTION

The present invention and related disclosure describes a new, novel way to add a three-dimensional contour to a greeting card by elevating a particular area of text and/or design by adding pinhole punches to the outline of the design. The unique and novel method of manufacturing the pinhole punched greeting card enables all pinholes to be created simultaneously but gives the impression of a handmade article wherein each individual pinhole was punctured by hand.

### DESCRIPTION OF THE DRAWINGS

FIGS. 1-8 illustrate embodiments of the pinhole punched greeting card of the present invention.

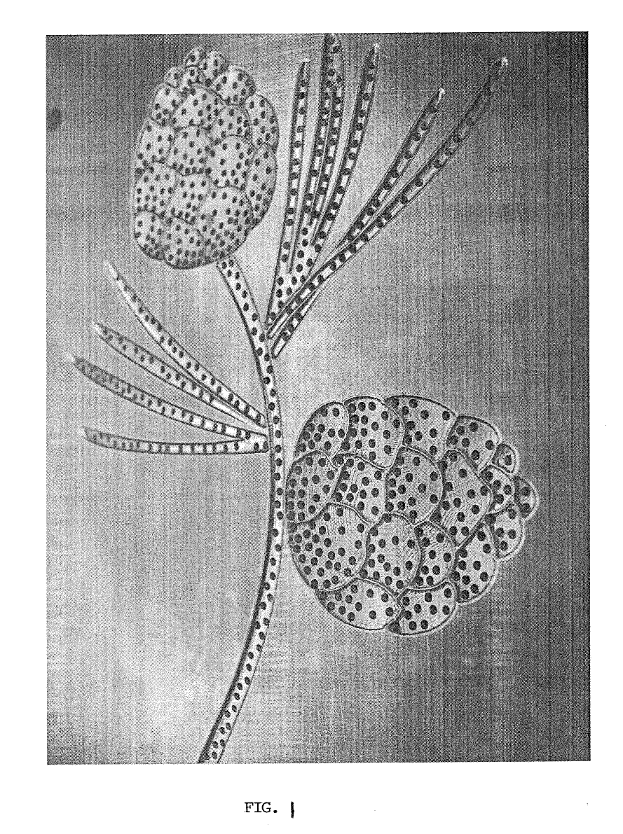

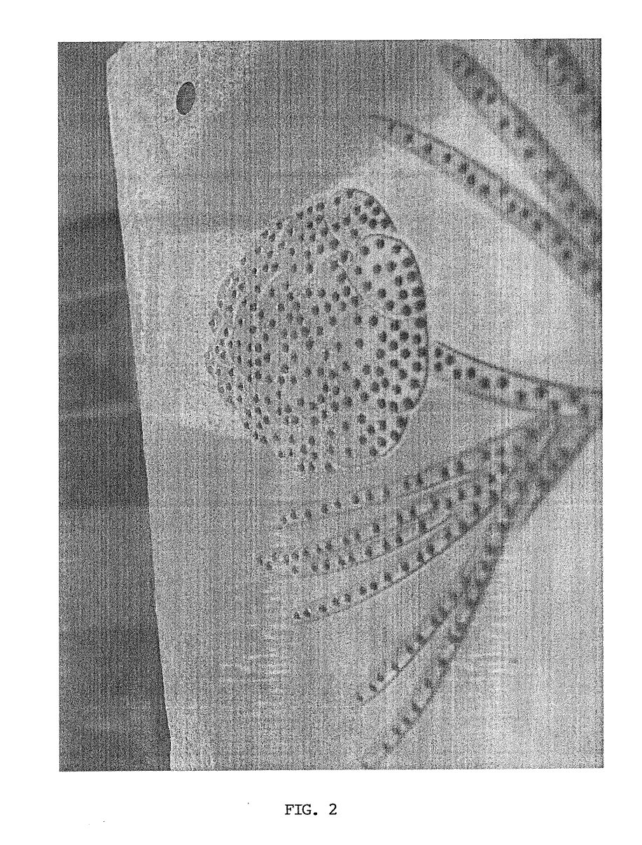

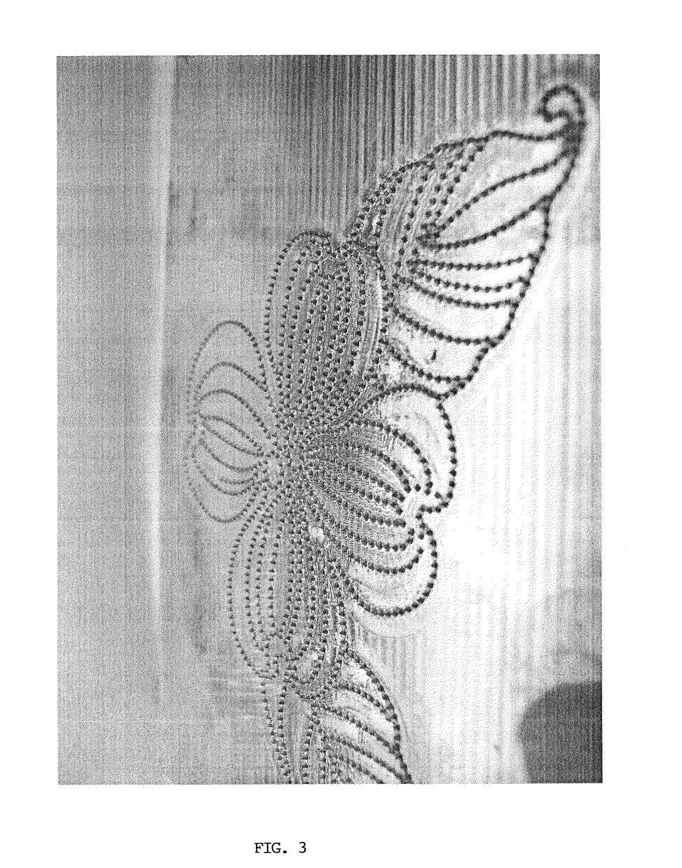

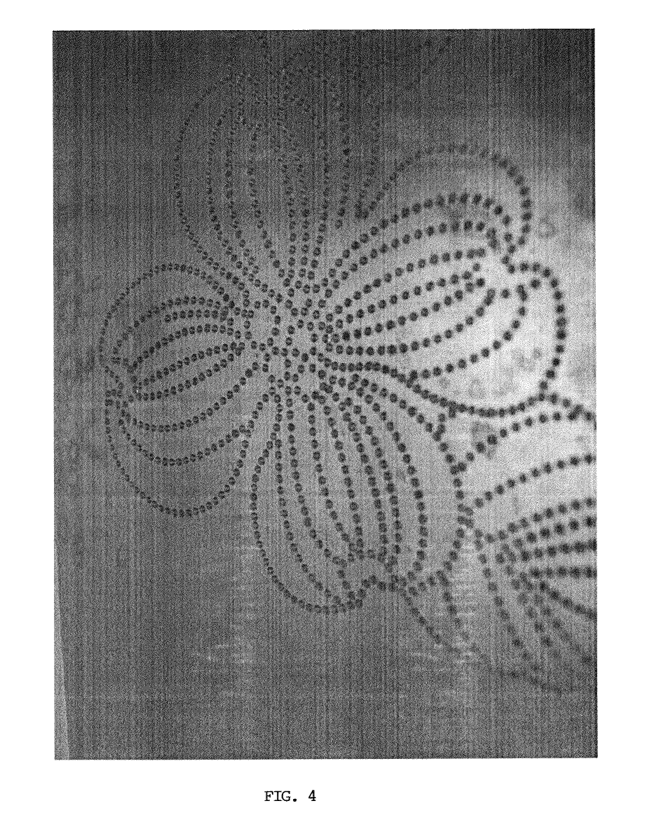

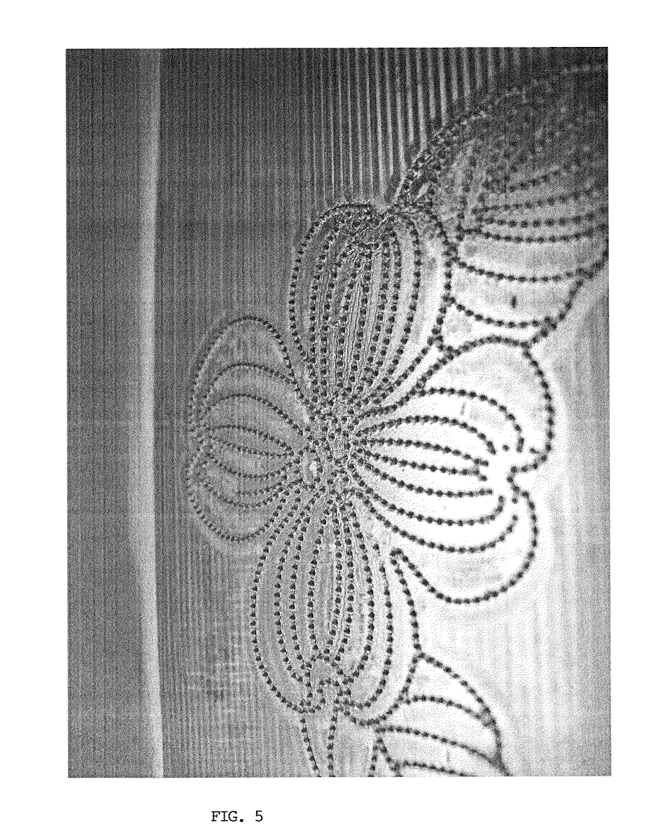

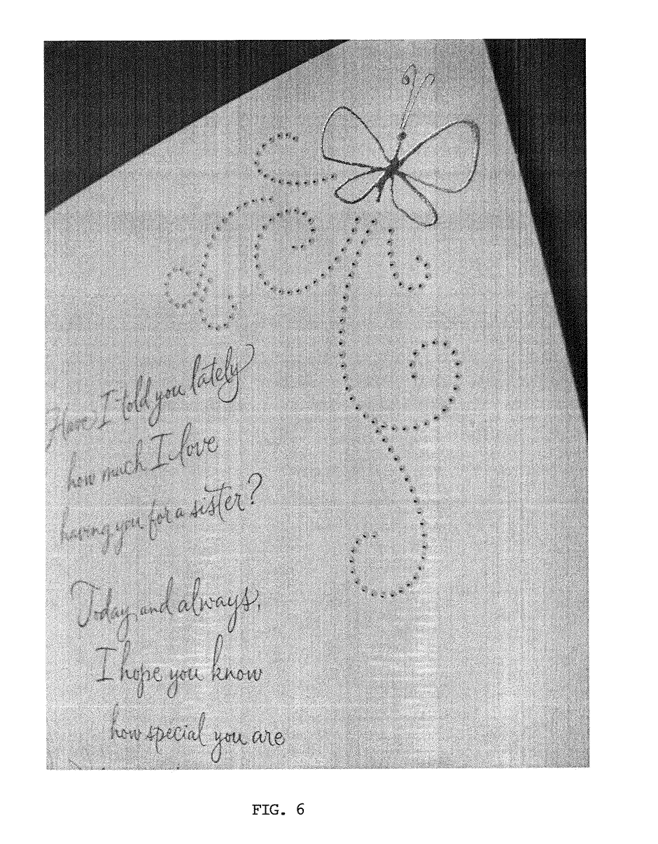

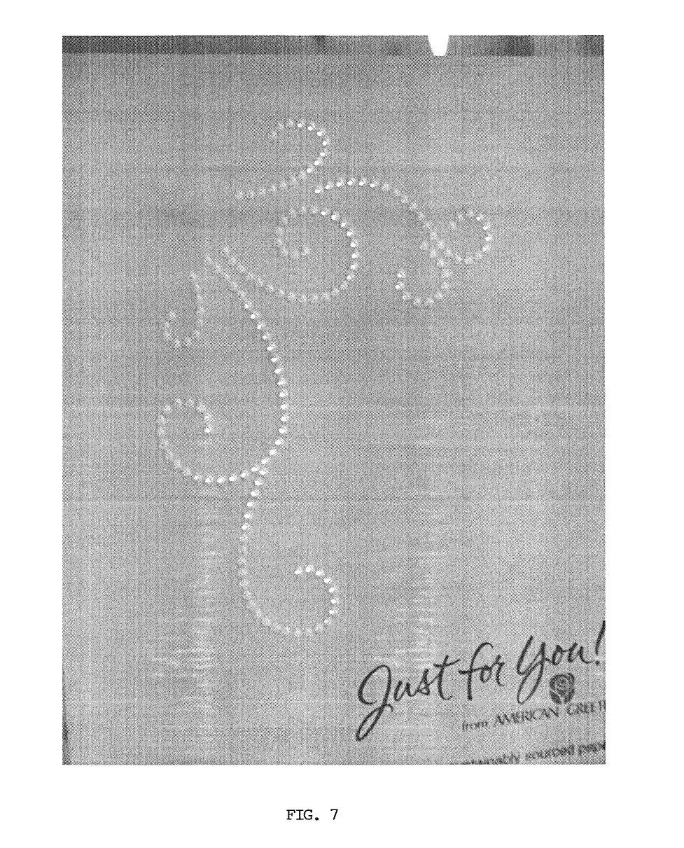

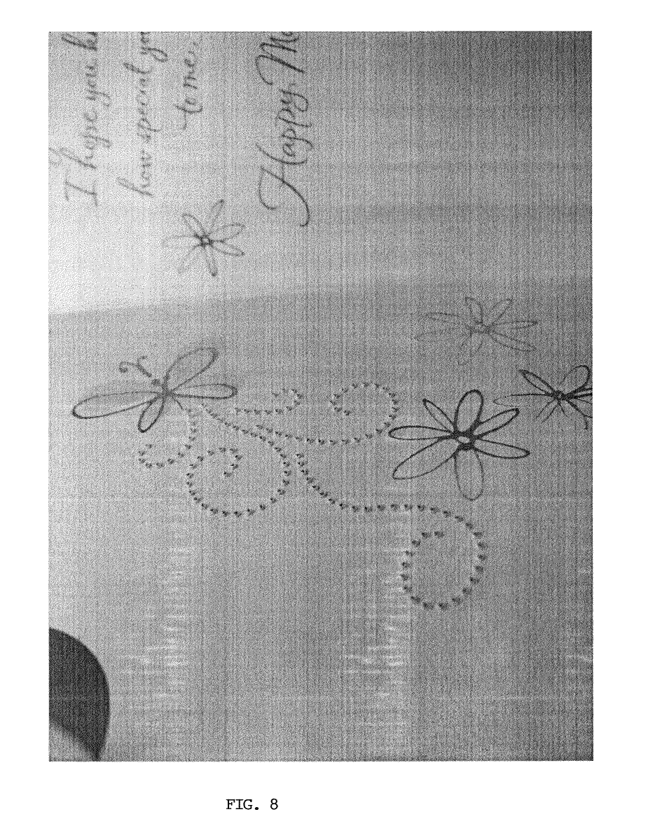

### DETAILED DESCRIPTION OF PREFERRED AND ALTERNATE EMBODIMENTS

The pinhole punched greeting card and method of manufacture of the present disclosure and related inventions replicates the hand made look of the pinhole art form, in which each depression in a card design creates a pin hole that actually breaks through the paper or card stock, but in a mass production process. The process creates a look that would otherwise be unavailable for production in large quantities.

The pinhole punched greeting card may be made of paper, cardstock, cardboard or other similar material. It may be a traditional two panel greeting card folded along a bisecting fold line or may contain any number of panels and corresponding fold lines enabling various greeting card configurations. The pinhole punched design may be contained on one or more panels of the greeting card and the design may consist of text sentiment, artwork design or a combination of both text and design. The pinhole punched design consists of a series of pinholes placed relatively close to one another and which trace out a design and/or text sentiment. Each of the pinholes contains an aperture at the center or point of a small cone-like structure created by a pointed cone-like die which pierces the greeting card at each pinhole point in the design. The small-cone like structure creates a raised surface which adds a three-dimensional form to the substantially planar surface of the greeting card. The pinholes may create a design including, for example, a flower, decorative border, or any other concrete or abstract design. The pinholes may also be used to trace and highlight text sentiment.

The process of creating a pinhole punched design can be performed by hand, by using a small straight pin to pierce a series of holes into a paper stock-like material in a particular fashion to create a design thereon. Alternatively, the pinhole punched designs may also be produced by a non-threaded sewing machine. Both the handmade and sewing machine methods of creating pinhole punched design greeting cards are expensive due to each being very time and labor intensive.

The process of mass producing pinhole punched design greeting cards is enabled by the present disclosure and related inventions. The process includes automating the process by simultaneously making each individual pinhole punch using a metal, preferably brass, die and counter. The male side of the die contains a series of protrusions, each protrusion having a 30-degree cone shape with a pointed top which pierces or punctures the pinhole into the greeting card. The base of each cone or opening in the die is approximately .040 to .050 inches in diameter and the depth of each cone or protrusion is approximately .040 to .050 inches. The female side of the counter is identical (mating) to the male side. A greeting card blank is placed between the die and counter. The die and counter are then pressed together to transfer the design contained upon the die and counter onto the greeting card as a pinhole punched design.

A typical embossment of a greeting card (without puncture holes) requires a female side of the die that is metal (often brass) and a male side that is typically some kind of non-metal or polymer. In some cases, both the male and female sides of the die are non-metal. In the present disclosure and related inventions, both the male and female sides of the die must be metal due to the cone-like protrusions in the male side of the die which are used to create the puncture or pinholes in the greeting card. Using a resin or polymer would create problems relating to the creation of the die wherein air may become trapped in the protrusion holes preventing a clean pour or contour of the material.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A pinhole punched greeting card comprising:
a greeting card body having at least one panel; and
a design impressed thereon comprising a plurality of raised pinholes placed in close proximity to each adjacent raised pinhole.

2. A method for mass producing pinhole punched greeting cards comprising the steps of:
creating a metal die containing a plurality of cone-shaped protrusions in the shape of a design to be impressed upon a greeting card, each cone-shaped protrusion having an angle of approximately 30 degrees, a diameter of between approximately .040 and .050 inches and a depth of between approximately .040 and .050 inches;
creating a metal die counter which is identical to the metal die but in reverse;
placing and securing a greeting card between the metal die and the metal die counter; and
compressing the metal die and the metal die counter together whereby the plurality of cone-shaped protrusions in the metal die create a plurality of raised pinhole punctures in the greeting card creating a design thereon.
